(19) United States
(12) Patent Application Publication
(10) Pub. No.: US 2020/0029622 A1
(43) Pub. Date: Jan. 30, 2020

(54) PORTABLE VAPORIZER

(71) Applicant: FLYTLAB LLC, Los Angeles, CA (US)

(72) Inventors: Alex Le-Tien FEI, Los Angeles, CA (US); Matthew Joseph RILEY, Billerica, MA (US)

(21) Appl. No.: 16/444,379

(22) Filed: Jun. 18, 2019

Related U.S. Application Data
(60) Provisional application No. 62/711,319, filed on Jul. 27, 2018.

(51) Int. Cl. A24F 47/00; A24F 9/16; F16J 15/02; H05B 1/02; G01F 1/56

(52) U.S. Cl. CPC A24F 47/008; A24F 9/16; G01F 1/56; H05B 1/0297; F16J 15/02

(57) ABSTRACT

A portable vaporizer includes a housing that has a spring-loaded cartridge chamber configured to accept a removable vaporizer cartridge. The portable vaporizer includes a lid configured to secure the cartridge in the cartridge chamber. The lid includes a seal and a vapor port through which a user can receive a vapor from the cartridge. The seal includes a vapor aperture configured to align with a mouth of the cartridge when the lid is closed and forms a closed fluidic path from the vapor port to the cartridge through the vapor aperture in the seal. The portable vaporizer includes a sensor configured to detect when a user inhales through the vapor port. The portable vaporizer controls an electrical current that is delivered to the cartridge to vaporize contents of the cartridge when the sensor detects that the user is inhaling through the vapor port.

### CROSS-REFERENCE TO RELATED APPLICATIONS

This application claims the benefit of U.S. Provisional No. 62/711,319, filed Jul. 27, 2018, which is herein incorporated by reference in its entirety.

### TECHNICAL FIELD

The subject application teaches embodiments that relate generally to an enclosure for vaporizer cartridges, and specifically to a vaporizer that produces vapor from an enclosed cartridge in response to sensing inhalation through a vapor port of the vaporizer by a user.

### SUMMARY

In an example embodiment, a portable vaporizer includes a housing with a movably connected lid. The lid is configured to secure a removable cartridge in a cartridge chamber associated with the housing. The lid includes a seal and a vapor port through which a user can receive a vapor. The seal includes a vapor aperture configured to align with a mouth of the removable cartridge when the lid is closed and forms a closed fluidic path from the vapor port to the cartridge through the vapor aperture in the seal. The portable vaporizer can include a sensor configured to detect when a user inhales through the vapor port and based on the detection the portable vaporizer controls an electrical current that is delivered to the removable cartridge for vaporizing contents of the removable cartridge into the vapor.

In another example embodiment, a portable vaporizer includes a housing, a cartridge chamber disposed in the house that is configured to accept a disposable cartridge, a battery disposed in the housing, and a sensor disposed in the housing that is in electrical communication with the battery and further configured to detect with a user attempts to inhale vapor from the portable vaporizer and control delivery of an electrical current to the disposable cartridge for vaporizing contents of the disposable cartridge into vapor.

In yet another example embodiment, a portable vaporizer includes a housing, a spring-loaded cartridge chamber disposed in the housing that is configured to accept a disposable cartridge, a battery, and a sensor. The battery is disposed in the housing and is configured to provide electrical current to the disposable cartridge for generating vapor. The sensor is disposed in the housing and is in electrical communication with the battery. The sensor is configured to control deliver of an electrical current from the battery to the disposable cartridge.

### BACKGROUND

Vaporizers have become an increasingly popular alternative to smoking. Commonly referred to as “vaping”, vaporizers provide a comparative clean and convenient way for users to inhale nicotine and other substances. Many vaporizers are comprised of two separate parts that are joined together prior to use, namely a vaporizer housing and a disposable cartridge. The vaporizer housing contains a battery, a switch and electrical contacts for connecting to the disposable cartridge. Some vaporizer housings are referred to as mods as they include advanced, or modified, features from standard vaporizer pens. The disposable cartridge contains an oil or other substances to be vaporized and the vaporizing elements for turning the oil into a vapor. Vaporizing elements in the disposable cartridges are generally heating coils and wicking that are capable of raising the temperature of wicked oil to below the flash point, which causes the oil to vaporize and produce vapor without igniting or burning.

Prior to vaping, a user inserts a disposable cartridge into the vaporizer housing. The user may need to configure the disposable cartridge for the vaporizer housing, for example by attaching a magnetic tip to the disposable cartridge. In these vaporizers, the magnetic tip holds the disposable cartridge in place in the vaporizer housing and facilitates easy removal and replacement of the disposable cartridge. In these vaporizers, the user inserts the disposable cartridge into the vaporizer, and a portion of the disposable cartridge remains outside the vaporizer housing which includes a mouth piece. In other vaporizers, the disposable cartridge is screwed onto the vaporizer housing in an end-to-end type configuration. Many disposable cartridges use a standardized connection so as to work with a variety of different vaporizer housings. For example, many disposable cartridges use the standard 510 size screw thread connector but each disposable cartridge may vary in length or width from brand to brand.

When the user desires vapor from a vaporizer the user presses a switch on the housing to cause the oil to be vaporized. The user places their mouth around the mouth piece of the disposable cartridge, presses a switch, and inhales the vapor that is produced. The user determines the amount of vapor that is produced by controlling the action of the switch. The user must coordinate the action of the switch with their inhalation in order to ensure they inhale the produced vapor. As a result of these two different actions, users often inhale somewhat different amounts of vapor each time they operate the vaporizer, resulting in inconsistent amounts of nicotine or other vaporized substances being delivered to the user from use to use.

### BRIEF DESCRIPTION OF THE DRAWINGS

FIG. 1 is a perspective view of a portable vaporizer.

FIG. 2 is a side view of a portable vaporizer in an unloaded configuration.

FIG. 3 is a partial side view of an alternative configuration of a lid of a portable vaporizer.

FIG. 4 a side view of a vaporizer cartridge.

FIG. 5 is a side view of a portable vaporizer with a vaporizer cartridge.

FIG. 6 is an example circuit diagram for a portable vaporizer.

### DETAILED DESCRIPTION

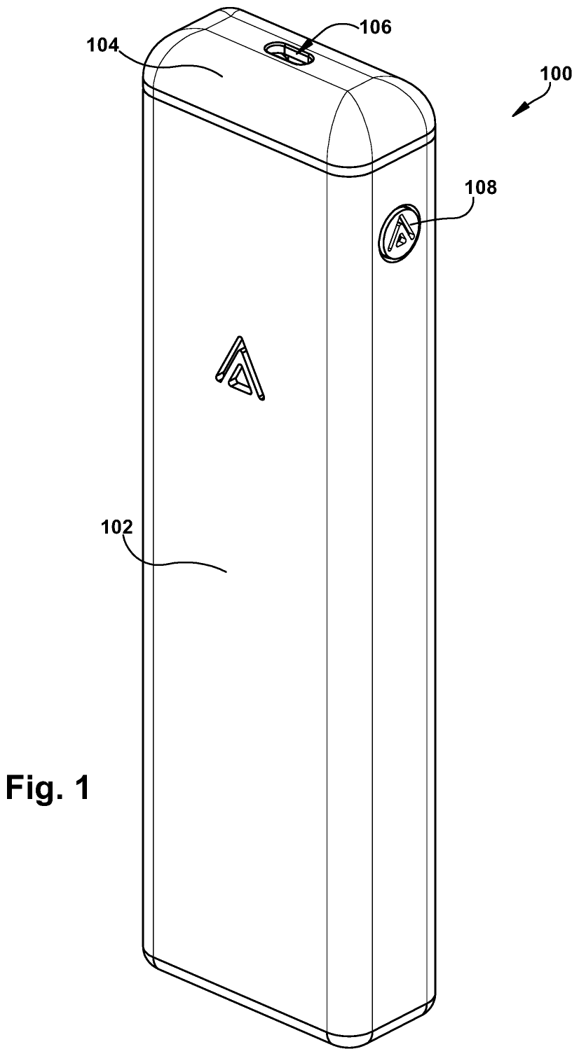

The systems and methods disclosed herein are described in detail by way of examples and with reference to FIGS. 1-6. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

The systems and methods disclosed herein describe a portable vaporizer configured to selectively emit vapor for recreation or for treatment of a variety of medical conditions.

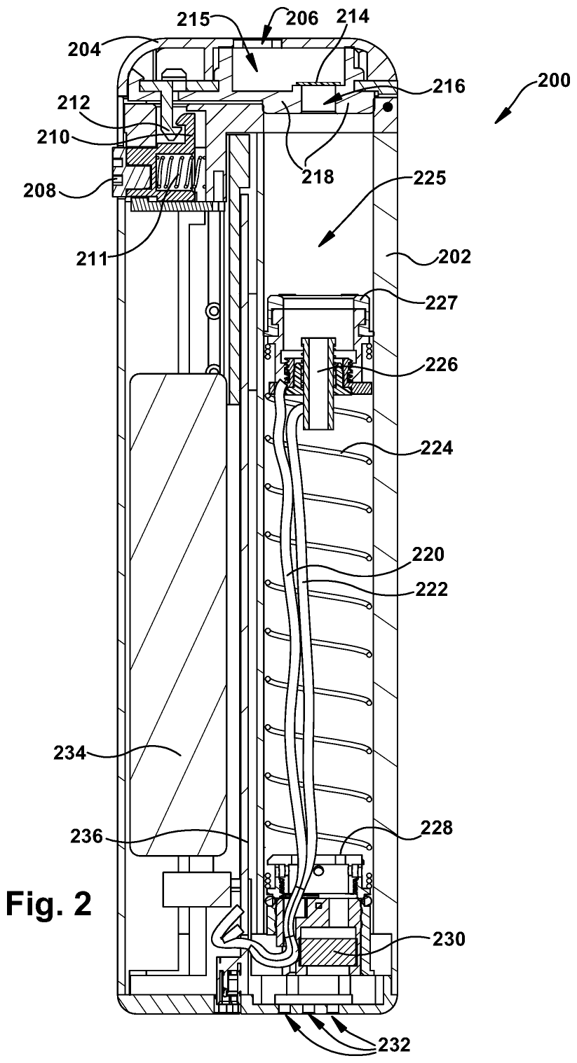

Referring now to FIG. 1, a perspective view of a portable vaporizer 100 is presented. The portable vaporizer 100 includes a housing 102 or shell, a lid 104, and a latch release 108. The lid 104 includes a vapor port 106 through which vapor can be inhaled by the user during use. The lid 104 is configured to be connected to the body 102, for example through a hinge which allows the lid 104 to rotate away from the housing 102 to expose the inside of the housing 102 when the latch release 108 is pressed. Additional operations of the portable vaporizer 100 are described below with regard to FIGS. 2-6.

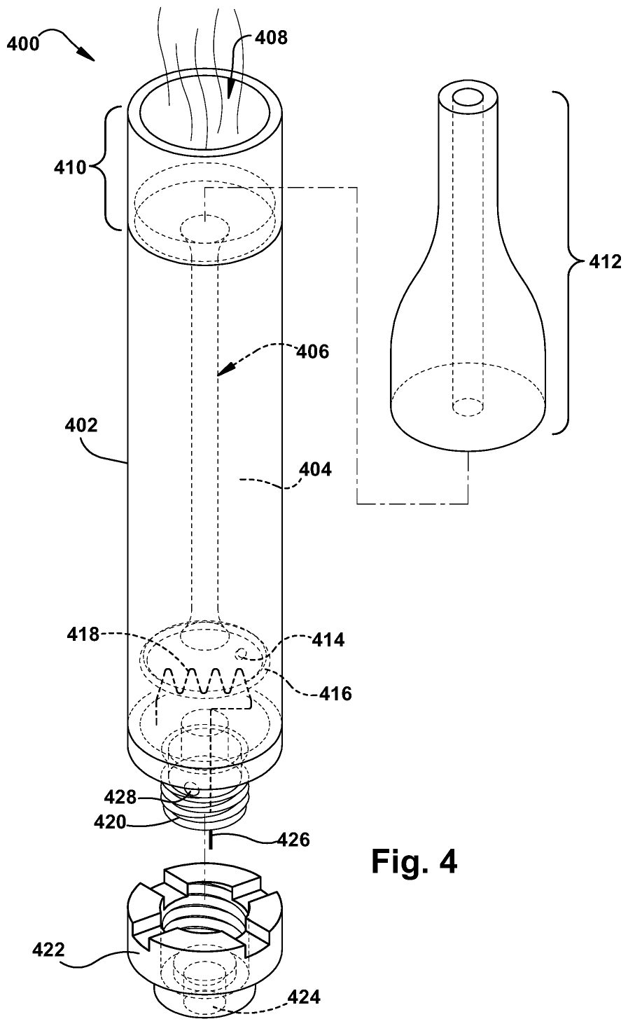

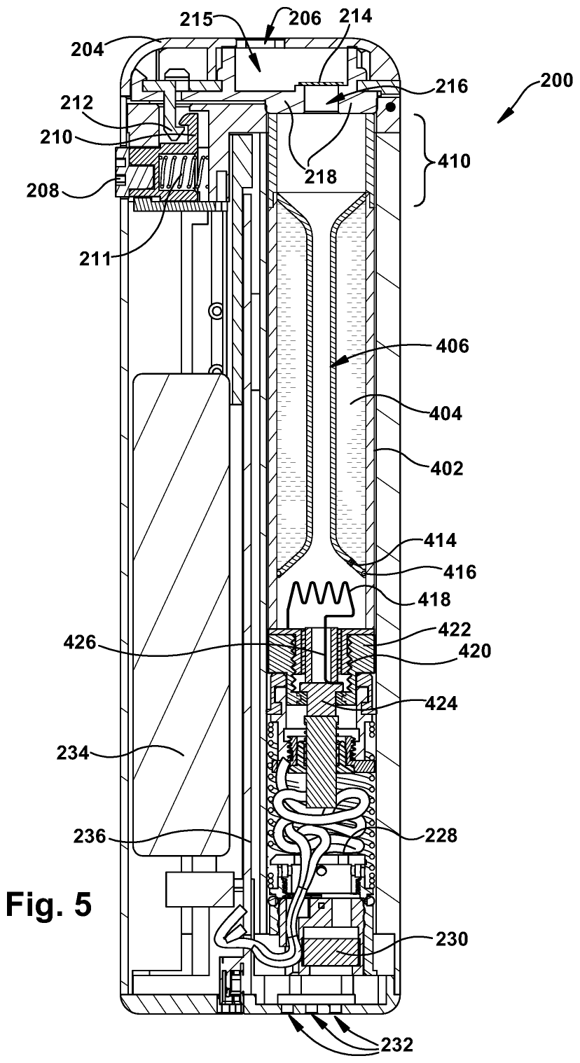

The body 102 and the lid 104 can be constructed from any suitable material, for example a suitable plastic such as polycarbonate or a metal as would be understood in the art. Advantageously, a disposable cartridge (not shown, see FIGS. 4 and 5) can be completely concealed inside of the portable vaporizer 100. While other vaporizers typically have a mouthpiece associated with the disposable cartridge that sticks out from the vaporizer, the portable vaporizer 100 does not require a mouthpiece to be used. This potentially reduces physical stresses on the disposable cartridge when the portable vaporizer is carried in a purse or pocket, and can provide a more sanitary vapor delivery experience to the user as well.

In embodiments, the lid can be disposed at the bottom of the portable vaporizer. In still other embodiments, the portable vaporized can be comprised of two or more individual pieces that can be secured together to secure the disposable cartridge within the portable vaporizer.

Referring now to FIG. 2, a cutaway view of a portable vaporizer 200 in an unloaded configuration is presented. The lid 204, or cover, is configured to be opened when the latch release 208 is pressed which compresses the biasing spring 211 and causes the latch 210 to disengage from the latch hook 212 associated with the lid 204. Once the lid 204 is unlatched, a disposable cartridge (not shown, see disposable cartridge 400 of FIGS. 4 and 5), which is biased by a coil spring 224, presses against the seal 218 which causes the lid 204 to rotate into the open configuration. In various configurations, additional biasing members or springs can be used to urge the lid 204 into the open configuration when the latch release 208 is pressed as would be understood in the art.

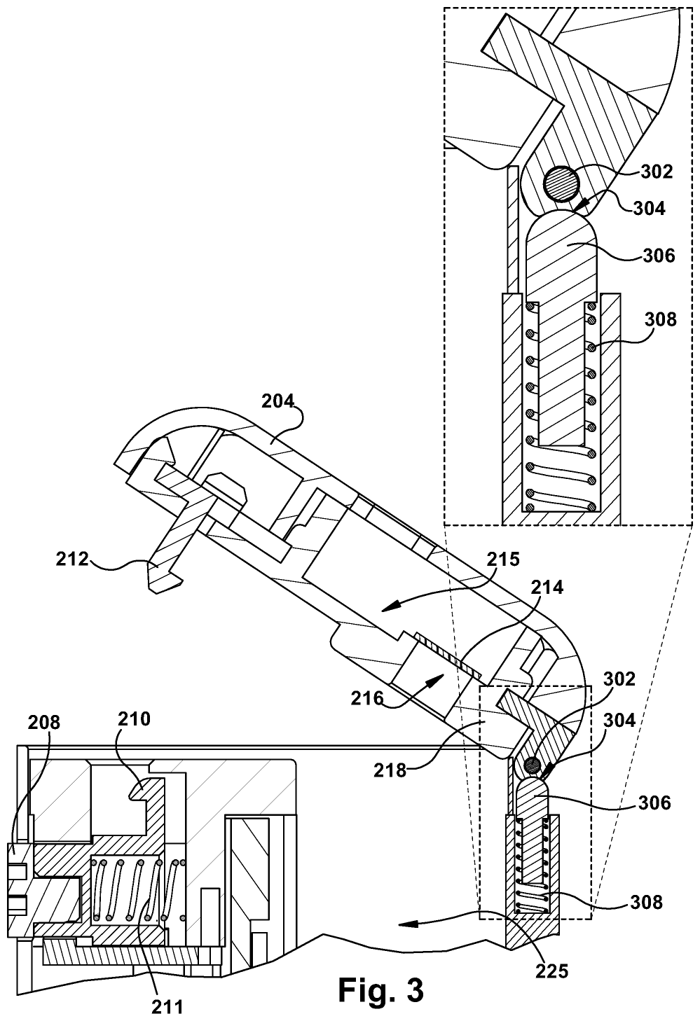

Referring now also to FIG. 3, an embodiment of a portable vaporizer 300 is illustrated with the lid 204, or cover, in the open configuration, for example for loading a new disposable cartridge into the cartridge chamber 225 or removing a used cartridge from the cartridge chamber 225. In this embodiment, the lid 204 has been released by the user pressing the latch release 208 which compressed the biasing spring 211 and caused the latch 210 to disengage from the latch hook 212.

To prevent accidental ejection of a disposable cartridge from the cartridge chamber 225 when the lid 204 is first opened, the hinge 302 includes an indented portion 304 configured to accept a rounded pin 306 mounted in the portable vaporizer 300 and biased by a biasing spring 308. When the lid 204 is opening, the lid 204 rotates around the hinge 302 and the indented portion 304 moves into a position opposite the rounded pin 306. The rounded pin 306 is biased by the biasing spring 308 into the indented portion 304 which impedes further rotation of the lid 204 around the hinge 302. A user can continue to rotate the lid 204 around the hinge 302 which will cause the indented portion 304 to urge the rounded pin 306 against the biasing spring 308. Once the lid 204 is sufficiently open, the user can remove a disposable cartridge from the cartridge chamber 225 or place a disposable cartridge into the cartridge chamber 225 and then close the lid 204.

Referring now also the FIG. 4, a disposable cartridge 400 includes a glass tube 402, an oil reservoir 404, a center tube 406, a mouth 410 which alternatively can be a shaped mouth 412 through which vapor can be withdrawn by a user, an oil aperture 414, a seal 416, an internal heating element 418, screw threads 420, and a center heating element wire 426. Air can be drawn into the disposable cartridge through a side air inlet 428 and/or a center air inlet 430. An optional magnetic base 422 is configured to screw onto the screw threads 420 of the disposable cartridge 400. The magnetic base 422 includes a center conductor 424 that is configured to contact the center heating element wire 426 when the magnetic base 422 is screwed onto the screw threads 420 of the disposable cartridge 400.

Oil or other vaporizable substances are stored in an oil reservoir 404. The glass tube 402 allows users to view the contents in the oil reservoir 404. A seal 416 ensures that oil remains in the oil reservoir 404 until vaporized. Oil in the oil reservoir 404 is drawn to the heating element 418 through an oil aperture 414, for example using a suitable wicking material (not shown). When energized by a suitable current, the oil is vaporized into vapor 408 by a heating element 418. The vaporized oil is mixed with air entering the side air inlet 428 and/or the center air inlet 430 to become the vapor 408. The vapor 408 is drawn up the center tube 406 into the open mouth 410 or shaped mouth 412 of the disposable cartridge 400.

Referring now also to the portable vaporizer 500 of FIG. 5, the lid 204 includes the latch hook 212 and the seal 218. The seal 218 is configured to secure a disposable cartridge 400 in the cartridge chamber 225. The seal 218 can be constructed from any suitable material such as silicon, rubber, or other gasket materials. The seal 218 includes a vapor aperture 216 that is configured to be seated against the mouth 410 of a disposable cartridge. The vapor aperture 216 is axially aligned with a center tube 416 associated with the disposable cartridge 400. The vapor aperture 216 directs vapor 408 that is received from the mouth 410 through the center tube 406 of the disposable cartridge 400 to a vapor chamber 215 that leads to the vapor port 206 through which a user can draw breathable vapor 504.

The lid 204 also includes a chamber seal 214 that covers the vapor aperture 216 when vapor 408 is not being drawn by the user. Advantageously, the chamber seal 214 helps to prevent any smell or stray vapor 408 from escaping from the portable vaporizer 500 when not in use. When the lid 204 is closed, the seal 218 presses against the mouth of the disposable cartridge 400 which pushes the disposable cartridge 400 into the cartridge chamber 225 against the coil spring 224. Advantageously, no additional attachment mechanism is needed to secure the disposable cartridge 400 in the cartridge chamber 225. For example, in many prior art vaporizers, a magnetic base 422 must be screwed onto the threads 420 of the disposable cartridge 400 in order to secure the disposable cartridge to a vaporizer. In other prior art vaporizers, the disposable cartridge 400 is secured to the vaporizer directly by the threads 420.

The coil spring 224 is attached to a heating element electrical contact 227 that is configured to accept the base of the disposable cartridge 400. When a disposable cartridge 400 is inserted into the cartridge chamber 225, the base of the disposable cartridge 400 contacts the heating element electrical contact 227. As the disposable oil cartridge is inserted into the cartridge chamber 225, the heating element electrical contact 227 compresses the coil spring 224. Flexible wires 220, 222 electrically connect the heating element electrical contact 227 and center electrode 226 to a circuit board 236.

Advantageously, the heating element electrical contact 227 is spring loaded by the coil spring 224 which permits a wide range of disposable cartridges 220 of different dimensions to be inserted into the cartridge chamber 225 and used in the portable vaporizer 500. Advantageously, the portable vaporizer 500 allows both portable cartridges 400 with a magnetic base 422 or without a magnetic base 422 to be used.

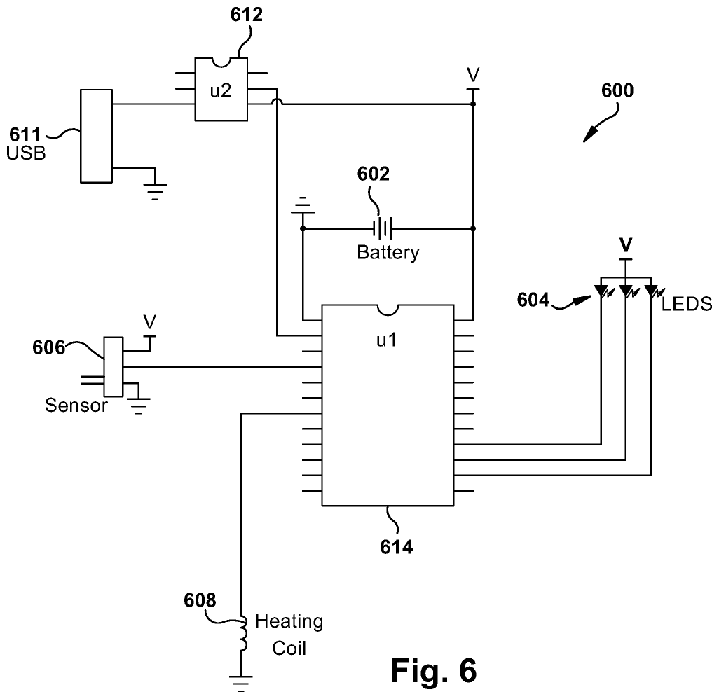

The portable vaporizer 200, 500 also includes a battery 234, for example a 650 MAH lithium-ion battery. The battery 234 can be charged via a USB port 238 or by any other suitable charging means as would be understood in the art. As described below in greater detail for FIG. 6, a circuit board 236 can detect when the lid 104 is opened or closed, to determine whether a disposable cartridge 400 has been inserted into the cartridge chamber 225. A sensor module 230 can determine when air 502 is being drawn through the air ports 232 indicating that the user is attempting to obtain vapor 504 by inhaling through the vapor port 206.

Closing the lid 204 seats the disposable cartridge 400 in the cartridge chamber 225 and activates the portable vaporizer 500 for use. In a configuration, the seating of the disposable cartridge 400 against the heating element electrical contact 227 and center electrode 226 closes an electrical circuit, enabling operation of the portable vaporizer 500. In an alternative configuration, closing the lid 204 and securing the latch hook 212 in the latch 210 closes an electrical circuit, enabling operation of the portable vaporizer 500. When the circuit is closed, the circuit board 236 can detect the battery level and provide a suitable indication, for example through light emitting diodes or LEDs.

The vapor port 206, vapor chamber 215, center tube 222, air inlet 223, and air ports 232 are in fluidic communication and form a closed fluidic path. When a user attempts to obtain vapor 504, for example by placing their mouth over the vapor port 206 and inhaling, the pressure drop in the vapor chamber 215 causes the chamber seal 214 to open, air is drawn through the center tube 222 from the air inlet 223, and air 502 from outside the portable vaporizer 500 is drawn through the air ports 232 past the sensor 230. The chamber seal 214 functions as a one way valve and restricts fluidic movement of vapor 504 and air 502 to a single direction.

A sensor 230 is configured to detect when a user attempts to obtain vapor 242 through the vapor port 206. In various configurations, one or more types of sensors can be used as the sensor 230. For example, in one configuration a pressure sensor can detect the drop in pressure. For example, an 811Z pressure sensor from Weifang Dongke Electric Co., LTD can be used as the pressure sensor. In another configuration, a sensor can detect when air 502 is flowing past the sensor, for example by measuring minute changes in capacitance. In another configuration, a sensor can detect changes in electrical conductance between the lid 204 and the housing 202 when the user places their mouth on the vapor port 206 of the lid 204.

When the sensor 230 detects that the user is attempting to obtain vapor 504, electricity from the battery 234 is delivered to the disposable cartridge 400 by the heating element electrical contact 227 and the center electrode 226. The electricity heats the vaporizing heating element 418 inside the disposable cartridge 400 which vaporizes oil (or liquids, concentrates, or waxes) in the disposable cartridge 400 into vapor 408. The vapor 408 is then carried up the center tube 406, through the vapor aperture 216 in the seal 218, past the chamber seal 214, into the vapor chamber 215, and finally drawn into the user's mouth as breathable vapor 504 through the vapor port 206.

Operation of the portable vaporizer 500 is triggered when the user inhales through the vapor port 106. Advantageously, the portable vaporizer 500 can be configured to deliver a precisely timed dose of vapor, resulting in the user receiving a consistent amount of breathable vapor 504 for each use. This operational mode also ensures that there is continuous air flow when vaporization occurs, creating a substantially homogenous vapor 504 for the user. The continuous air flow during vapor generation also reduces the possibility of localized overheating at the heating element 418 inside the disposal cartridge 400. This mode of operation also ensures that vapor 408 is only generated when the user is inhaling, which reduces the amount of vapor 408 that might otherwise be generated and later condense on internal surfaces of the portable vaporizer 500 as typically occurs in prior art push button systems requiring periodic cleaning and removable of buildup. Advantageously, no additional power button is required for operation, which eliminates a potential point of failure and also improves the water resistant characteristics of the portable vaporizer 500.

Referring now to FIG. 6, an example circuit 600 is presented. A USB port 610 and associated integrated circuit 612 allows a user to charge the battery 602 and configure the operation of a portable vaporizer. An integrated circuit 614 controls operation of the portable vaporizer, for example by monitoring the pressure sensor 606, sensing whether a disposable cartridge is present, for example by sensing a completed circuit through the heating element 418, providing a suitable voltage or range of voltages and current to the heating element 608 of the disposable cartridge, and providing one or more indications to users through LEDs 604.

The integrated circuit can control operation of the LEDs 604 to provide information about the battery 602 level when the portable vaporizer is being charged through the USB port. When a disposable cartridge is inserted into the portable vaporizer, the integrated circuit can illuminate one or more of the LEDs 604 to provide battery 602 level indications and/or the voltage levels that have been configured for energizing the heating element 608 during use. During use, the LEDs 604 can provide indications of the voltage levels for the heating element 608 and/or indications that vapor is being produced. The LEDs 604 can provide other indications and use color and/or flashing to provide suitable indications as would be understood in the art.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A portable vaporizer, comprising:
a housing including a cartridge chamber; and
a lid that is movably connected to the housing and configured to secure a cartridge in the cartridge chamber when the lid is in a closed configuration;
a vapor port through which a user can receive a vapor; and
a seal that includes a vapor aperture configured to align with a mouth of the cartridge when the lid is closed to form a closed fluidic path from the vapor port through the vapor aperture in the seal to the cartridge.

2. The portable vaporizer of claim 1, wherein the housing further includes a latch and a latch release,
wherein the lid includes a latch hook,
wherein the latch and latch hook are configured to maintain the lid in the closed configuration when the latch release is not pressed, and
wherein the lid is configured to transition from the closed configuration to an open configuration when the latch release is pressed.

3. The portable vaporizer of claim 1, wherein the lid includes a vapor chamber configured to provide a closed fluidic path between the vapor port and the vapor aperture in the seal.

4. The portable vaporizer of claim 3, wherein the lid further includes a chamber seal configured to restrict fluidic movement of a vapor in the closed fluidic path to a single direction.

5. The portable vaporizer of claim 1, wherein the housing further includes one or more air ports configured to permit air to be drawn into the housing.

6. The portable vaporizer of claim 1, wherein the housing further includes
a battery, and
a universal serial bus port for charging the battery.

7. The portable vaporizer of claim 1, wherein the cartridge chamber includes a coil spring,
wherein the coil spring is configured to bias the mouth of the cartridge against the seal, and
wherein compression of the coil spring by the cartridge completes an electrical circuit which enables operation of the portable vaporizer.

8. The portable vaporizer of claim 7, wherein the coil spring is in communication with a heating element electrical contact,
wherein the heating element electrical contact is configured to accept the cartridge, and
wherein the heating element electrical contact is configured to compress the spring as the cartridge is inserted into the chamber and the lid is closed.

9. The portable vaporizer of claim 1, further comprising:
a sensor configured to detect when a user inhales through the vapor port and control an electrical current delivered to the cartridge for vaporizing contents of the cartridge into a vapor.

10. The portable vaporizer of claim 9, wherein the sensor is configured to detect one or more of a drop in air pressure, an increase in air flow, a change in electrical conductivity, or a change in capacitance.

11. A portable vaporizer, comprising:
a housing;
a cartridge chamber disposed in the housing and configured to accept a disposable cartridge;
a battery disposed in the housing; and
a sensor disposed in the housing and in electrical communication with the battery and configured to
detect when a user attempts to inhale a vapor from the portable vaporizer, and
control delivery of an electrical current to the disposable cartridge for vaporizing contents of the disposable cartridge into the vapor.

12. The portable vaporizer of claim 11, wherein the sensor is configured to detect one or more of a drop in air pressure, an increase in air flow, a change in electrical conductivity, or a change in capacitance.

13. The portable vaporizer of claim 11, wherein the housing further includes
a universal serial bus port configured for charging the battery.

14. The portable vaporizer of claim 11, further comprising:
a coil spring disposed in the cartridge chamber; and
a heating element electrical contact that is in communication with the coil spring and configured to accept the disposable cartridge,
wherein insertion of the disposable cartridge in the cartridge chamber compresses the coil spring and completes an electrical circuit thereby enabling operation of the portable vaporizer.

15. The portable vaporizer of claim 11, further comprising:
a lid including
a vapor port,
a seal including a vapor aperture, and
a vapor chamber,
wherein the lid is movably connected to the housing and configured to secure the disposable cartridge in the cartridge chamber when the lid is in a closed configuration,
wherein the coil spring is further configured to bias the mouth of the cartridge against the seal, and
wherein the vapor aperture is configured to align with a mouth of the disposable cartridge when the lid is closed to form a closed fluidic path between the vapor port, the vapor chamber, the vapor aperture, and the mouth of the disposable cartridge.

16. The portable vaporizer of claim 15, wherein the lid further includes a chamber seal configured to restrict fluidic movement of a vapor in the closed fluidic path to a single direction.

17. The portable vaporizer of claim 15, wherein the housing further includes a latch and a latch release,
wherein the lid further includes a latch hook,
wherein the latch and latch hook are configured to maintain the lid in the closed configuration when the latch release is not pressed, and
wherein the lid is configured to transition from the closed configuration to an open configuration when the latch release is pressed.

18. A portable vaporizer, comprising:
a housing;
a spring-loaded cartridge chamber disposed in the housing and configured to accept a disposable cartridge;
a battery disposed in the housing configured to provide electrical current to the disposable cartridge for generating a vapor; and
a sensor disposed in the housing and in electrical communication with the battery and configured to control delivery of an electrical current from the battery to the disposable cartridge.

19. The portable vaporizer of claim 18, further comprising:
a heating element electrical contact that is in communication with a coil spring of the spring-loaded cartridge chamber,
wherein the heating element electrical contact is configured to pass the electrical current to a heating element inside the disposable cartridge, and
wherein insertion of the disposable cartridge into the spring-loaded cartridge chamber compresses the coil spring and completes an electrical circuit between the sensor and the battery thereby enabling operation of the portable vaporizer.

20. The portable vaporizer of claim 18, further comprising:
a lid rotatably connected to the housing and configured to secure the disposable cartridge in the spring-loaded cartridge chamber when the lid is rotated closed,
wherein the lid includes a latch hook configured to maintain the lid in the closed configuration, and further includes a seal, and a vapor port through which a user can receive the vapor,
wherein the coil spring is further configured to bias the disposable cartridge against the seal,
wherein the housing includes a latch release configured to release the latch hook to open the lid, uncompress the coil spring, and open the electrical circuit thereby disabling operation of the portable vaporizer.
